(19) United States
(12) Patent Application Publication
(10) Pub. No.: US 2006/0070240 A1
(43) Pub. Date: Apr. 6, 2006

(54) Shaving implement

(75) Inventor: Stephan Fischer, Gevelsberg (DE)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/244,093

(22) Filed: Oct. 5, 2005

Related U.S. Application Data
(60) Provisional application No. 60/616,342, filed on Oct. 5, 2004.

(51) Int. Cl. B26B 21/00; B26B 21/14

(52) U.S. Cl. 30/50; 30/81

(57) ABSTRACT

A guard for a razor cartridge has a skin-engaging surface and a plurality of arcuate channels formed therein that, when the guard is incorporated into a shaving implement and used to shave, pre-stretch the skin in directions forward of razor blades of the cartridge and outward towards the edges of the cartridge. A razor cartridge has a plurality of skin-engaging elements mounted on a frame having two ends, the skin-engaging elements including at least one blade having a sharpened cutting edge; a cap positioned aft of the at least one blade; and a guard positioned forward of the at least one blade, the guard having a skin-engaging surface and a plurality of arcuate channels that pre-stretch the skin and distribute water and/or shaving aid material along the cutting edge of the blade. A wet shaving system has a handle and the razor cartridge mounted thereon.

### CROSS-REFERENCE TO RELATED APPLICATION

This application claims priority to U.S. Provisional Patent Application No. 60/616,342 filed on Oct. 5, 2004, the contents of which are incorporated herein by reference in their entirety.

### TECHNICAL FIELD

This invention relates generally to razor cartridges and, more particularly, to guards disposed on razor cartridges.

### BACKGROUND OF THE INVENTION

Conventional wet shaving systems include a handle and a razor cartridge. Typically, razor cartridges have several skin-engaging elements mounted on a frame, the skin-engaging elements including at least one razor blade, a guard, and a cap. In some embodiments, the razor cartridge and the handle are formed as a single, unitary piece. The razor cartridge and handle in these “disposable razor units” are used together until the razor blades are dulled. Once worn, the entire disposable razor unit is discarded and a new disposable razor unit is used in place of the discarded one. In other embodiments, the razor cartridge is removably attached to a reusable handle. In these applications, the razor cartridge is attached to the handle and used until the blades are dulled. The user then selectively replaces the worn razor cartridge with a new one on the same handle for continued shaving.

In a typical razor cartridge, the skin-engaging elements are positioned on the frame such that the guard is forward of the blades and the cap is aft of the blades. The terms “forward” and “aft,” as used herein, define the relative position between features of the razor cartridge. A skin-engaging element “forward” of the blades is positioned such that the surface to be shaved encounters that feature prior to encountering the blades during normal shaving operation. Conversely, a skin-engaging element “aft” of the blades is positioned such that the surface to be shaved encounters that feature only after encountering the blades during normal shaving.

During a use of a typical razor cartridge, some surfaces to be shaved are often too fleshy or fatty, which results in excess skin flow over the razor blades. When the skin flow over the blades exceeds the capabilities of the razor, the skin is nicked or cut. One way to avoid this type of overflow condition is to pull the skin in front of the razor blades taut during the shaving operation using the fingers of the free hand. However, pulling the skin taut with the fingers is not always possible or desirable, as the skin surface is typically coated with shaving aid.

It would be desirable to provide a shaving implement having a guard with a surface formed of flexible skin-engaging members to pre-stretch the skin prior to being shaved by the razor blade.

It would also be desirable to provide an array of skin-engaging members on the guard which act to trap and evenly redistribute water and shaving aid (e.g., shaving cream) forward of the blades.

### SUMMARY OF THE INVENTION

In one aspect, the present invention is directed to a guard for a razor cartridge. The guard has a skin-engaging surface and a plurality of arcuate channels formed therein that, when the guard is incorporated into a shaving implement and used to shave, pre-stretch the skin in directions forward of razor blades of the cartridge and outward towards the edges of the cartridge.

In a second aspect, the present invention is directed to a razor cartridge having a plurality of skin-engaging elements mounted on a frame having two ends. The skin-engaging elements include at least one blade having a sharpened cutting edge; a cap positioned aft of the at least one blade; and a guard positioned forward of the at least one blade, the guard having a skin-engaging surface and a plurality of arcuate channels that pre-stretch the skin and distribute water and/or shaving aid material along the cutting edge of the blade.

In a third aspect, the present invention is directed to a wet shaving system having a handle and a razor cartridge mounted thereon, the razor cartridge having a plurality of skin-engaging elements mounted on a frame. The skin-engaging elements include at least one blade having a sharpened cutting edge; a cap positioned aft of the at least one blade; and a guard positioned forward of the at least one blade, the guard having a skin-engaging surface and a plurality of arcuate channels that pre-stretch the skin being shaved and redistribute water and/or shaving aid material.

One advantage of the present invention is that the arcuate channels facilitate the close cutting of the hairs to be shaved. Because the arcuate shape is convex in the direction in which the guard of the present invention is stroked, the skin is stretched in the direction of the shaving stroke and outward towards the ends of the frame. By stretching the skin in this manner, the skin is pulled taught, thereby allowing the skin to be flattened and the hairs to be more erectly positioned in preparation for being cut.

Another advantage of the present invention is that the arcuate channels trap water and shaving aid on the skin surface during the shaving operation. By doing so, a leveling effect is realized with regard to the skin surface. Accordingly, a thin, uniform film of water and/or shaving aid is left on the skin surface for the razor blades to slide over, which thereby provides a smooth shave.

Another advantage is that the arcuate shape of the channels allows the trapped water and/or shaving aid to be distributed along the lengths thereof. As a shaving stroke is executed, the forward movement of the stroke allows the water and/or shaving aid to be forced back through the channels in the directions of the points at which the channels terminate. Shaving debris (e.g., cut whiskers and the like) may also be directed through the channels and away from the cutting edges of the razor blades.

### BRIEF DESCRIPTION OF THE FIGURES

FIG. 1 is a perspective view of a cartridge with a guard of the present invention mounted on a handle.

FIG. 2 is a perspective view of the cartridge of FIG. 1.

FIG. 3 is a front view of the cartridge of FIG. 1.

FIG. 4 is a sectional view of the cartridge of FIG. 1.

FIG. 5 is a sectional view depicting one embodiment of the guard of the present invention.

FIG. 6 is a sectional view depicting one embodiment of the guard of the present invention.

### DETAILED DESCRIPTION OF THE PREFERRED EMBODIMENTS

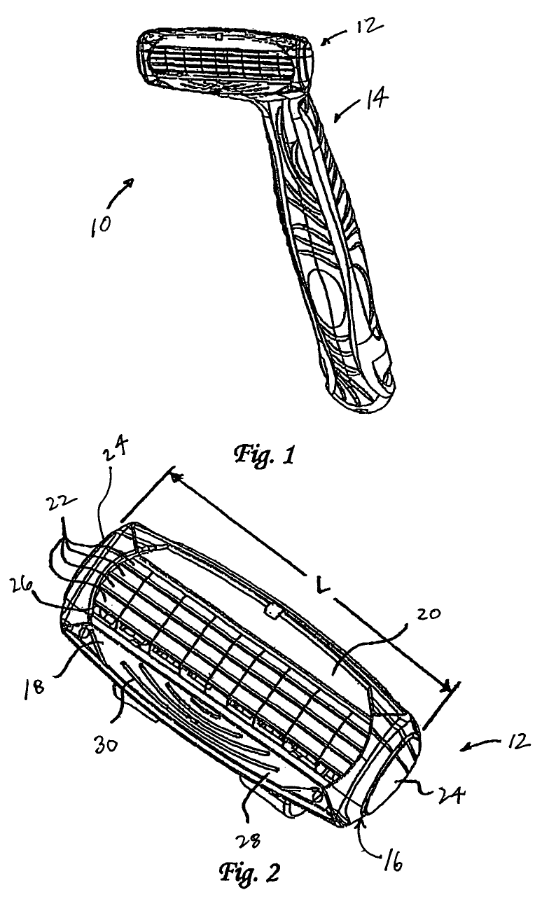

Referring to FIG. 1, a wet-shave razor system is shown generally at 10 and is hereinafter referred to as “system 10.” System 10 comprises a razor cartridge 12 attached to a handle 14. The cartridge 12 may be permanently attached to the handle 14, or it may be removably connected to the handle to allow the razor cartridge to be changed when the hair cutting devices thereof (hereinafter referred to as razor blades, although other devices are within the scope of the invention) become dulled and warrant replacement. In either configuration, the cartridge 12 may be pivotally attached or connected to the handle 14 to allow for the pivotal movement of the razor blades relative to the skin surface to be shaved.

Referring now to FIGS. 2 and 3, the cartridge 12 comprises a frame 16 that defines a plurality of skin-engaging elements. The skin-engaging elements generally facilitate the functions associated with a shaving operation, namely, stretching the skin in preparation for shaving, applying a lubricant or other skin-conditioning aid to the skin, and removing oils, shaving debris, and/or excess water from the skin surface. The skin-engaging elements comprise a guard 18, a cap 20, and at least one razor blade 22. The guard 18 forms a forward portion of the cartridge 12 and is positioned forward of the razor blades 22. The cap 20 forms an aft portion of the cartridge 12 and is positioned behind the razor blades 22. The guard 18 and the cap 20, which may be joined together at end surfaces thereof or respectively joined to discrete end walls 24, define an opening. The razor blades 22 are mounted longitudinally in the opening over a length “L” of the cartridge 12, each razor blade 22 having a sharpened edge 26 suitable for cutting hair. Although the description hereinafter refers to razor blades in the plural, it should be understood that the present invention may utilize only one razor blade.

The guard 18 extends at least part way across the length L of the cartridge 12 and includes a skin-engaging surface 28 and one or more channels 30 that extend lengthwise on an upper surface of the skin-engaging surface. The channels 30 are preferably arcuate in shape such that the midpoints of the channels substantially correspond to the midpoints of the razor blades 22. The ends of the channels 30 extend back towards the sides or end walls 24 of the frame 16 to stretch the skin by a desired amount in the directions indicated by arrows 32 (FIG. 3) prior to the cutting edges 26 of the razor blades 22 engaging the hairs. Several channels 30 are preferably disposed on the guard 18, each having a radius that progressively varies in the forward-to-aft direction. The channels 30 may be cut, etched, molded into, or otherwise suitably formed in the surface of the guard 18.

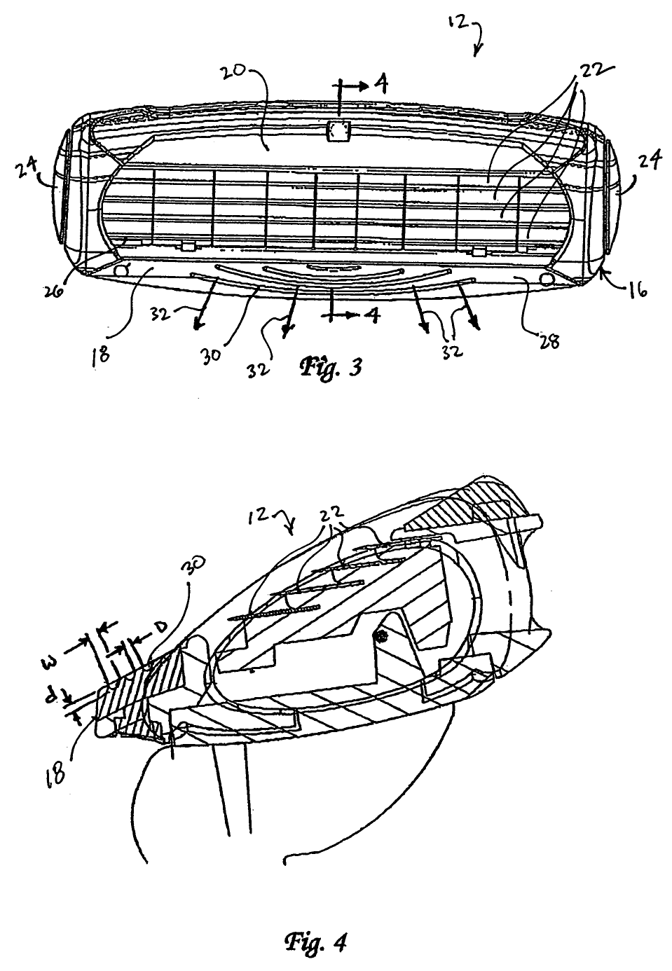

As can be best seen in FIG. 4, the channels 30 each have a width “w,” which may either be the same or different for each channel, and which may either be the same or different along the length of each channel. Each channel 30 also has a depth “d,” which, as with the width w, may be the same or different for each channel and which may either by the same or different along the length of each channel. In any channel 30, the width w and the depth d are sufficient to trap excess water and/or shaving aid applied to the skin prior to shaving and to redistribute such water and/or shaving aid during a shaving stroke. Also, because the skin-engaging surface is pressed against the surface being shaved, a leveling effect is realized, thereby allowing a thin film of water and/or shaving aid to be distributed over the skin during a shaving stroke. Furthermore, the width w and depth d may be sufficient to allow shaving debris to be removed from the skin and either pushed to the sides of the cartridge 12 or at least evenly distributed in front of the blades 22.

In embodiments in which two or more channels 30 are employed, each channel is also separated from adjacent channels by a distance “D,” which, as with the width w and depth d, may be the same or may vary.

The guard 18 is manufactured from any suitable flexible material. Suitable flexible materials that may be used include, but are not limited to, elastomeric materials such as natural or synthetic rubbers and the like, foams, thermoplastic materials of appropriate flexibility, thermoset materials, and combinations of the foregoing materials.

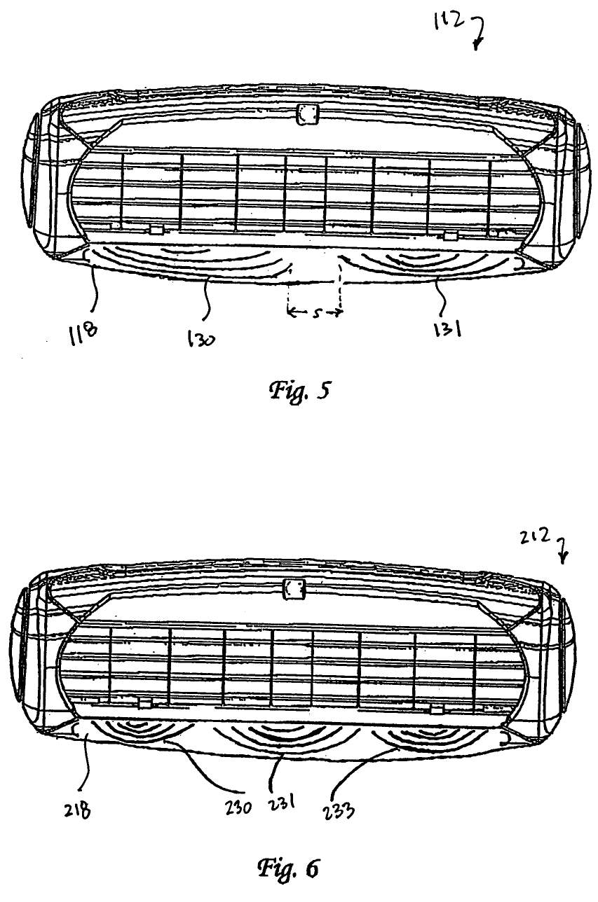

In alternative embodiments, a guard of a razor cartridge may include two or more sets of arcuately-shaped channels. Referring now to FIG. 5, a cartridge 112 is shown in which a guard 118 is shown in which two sets of arcuately-shaped channels are positioned on an upper surface thereof. The first set (shown at 130) is positioned on one side of the guard 118, while the second set (shown at 131) is positioned on the other side of the guard 118. Preferably, the space “s” defined between the first set 130 and the second set 131 is dimensioned to provide optimal skin-stretching effects during a shaving operation. Referring now to FIG. 6, a razor cartridge 212 having a guard 218 is shown in which three sets of arcuately-shaped channels are positioned on an upper surface thereof. Each set (shown at 230, 231, and 233, respectively) is positioned such that during a shaving operation, an optimal skin-stretching effect is provided. In any embodiment of a razor cartridge in which two or more sets of arcuate channels are utilized, the sets may be equidistantly positioned on the skin-engaging surface.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A guard for a razor cartridge, the guard comprising:
a skin-engaging surface; and
a plurality of arcuate channels formed in the skin-engaging surface;
wherein the arcuate channels are configured to pre-stretch the skin during shaving in a direction forward of a razor blade positioned in the razor cartridge and towards opposing ends of the razor blade prior to encountering the razor blade; and
wherein the arcuate channels are configured to trap and evenly distribute shaving aid on the skin forward of the razor blade on the surface being shaved.

2. The guard of claim 1, wherein the skin-engaging surface extends at least part way across a length of the razor cartridge.

3. The guard of claim 1, wherein the arcuate channels extend lengthwise on an upper surface of the skin-engaging surface.

4. The guard of claim 1, wherein midpoints of the arcuate channels substantially correspond to a midpoint of the razor blade.

5. The guard of claim 1, wherein ends of the arcuate channels extend back towards the opposing ends of the razor blade.

6. The guard of claim 1, wherein at least one of the arcuate channels has a radius that varies from at least one other of the arcuate channels.

7. The guard of claim 1, wherein the arcuate channels are cut, etched, or molded into the skin-engaging surface.

8. The guard of claim 1, wherein the guard is manufactured from a rubber, foam, a thermoplastic material, a thermoset material, or a combination of at least two of the foregoing materials.

9. The guard of claim 1, wherein the plurality of arcuate channels comprises at least two sets of pluralities of arcuate channels.

10. The guard of claim 9, wherein the at least two sets of pluralities of arcuate channels are equidistantly positioned on the skin-engaging surface.

11. A razor cartridge, comprising:
a plurality of skin-engaging elements mounted on a frame having two ends, the skin-engaging elements comprising:
at least one blade having a sharpened cutting edge;
a cap positioned aft of the at least one blade; and
a guard positioned forward of the at least one blade, the guard having a skin-engaging surface and a plurality of arcuate channels;
wherein the arcuate channels are configured to pre-stretch the skin in a direction forward of the blades and towards the two ends of the frame prior to encountering the at least one blade; and
wherein the arcuate channels are configured to trap and evenly distribute shaving aid on the skin forward of the at least one blade on the surface being shaved.

12. The razor cartridge of claim 11, wherein the two ends of the frame are each defined by an end wall.

13. The razor cartridge of claim 11, wherein the arcuate channels extend lengthwise on the skin-engaging surface.

14. The razor cartridge of claim 11, wherein at least one of the arcuate channels has a radius that varies from at least one other of the arcuate channels.

15. The razor cartridge of claim 11, wherein each of the arcuate channels is defined by a curved channel having a midpoint that corresponds substantially with a midpoint of the guard and opposing ends that extend rearward towards the two ends of the frame.

16. The razor cartridge of claim 11, wherein the plurality of arcuate channels comprises at least two sets of pluralities of arcuate channels.

17. A wet shaving system, comprising:
a handle;
a razor cartridge mounted on the handle, the razor cartridge having a plurality of skin-engaging elements mounted on a frame, the skin-engaging elements comprising:
at least one blade having a sharpened cutting edge;
a cap positioned aft of the at least one blade; and
a guard positioned forward of the at least one blade, the guard having a skin-engaging surface and a plurality of arcuate channels;
wherein the arcuate channels are configured to pre-stretch the skin in a direction forward of the blades and towards the two ends of the frame prior to encountering the at least one blade; and
wherein the arcuate channels are configured to trap and evenly distribute shaving aid on the skin forward of the at least one blade on the surface being shaved.

18. The wet shaving system of claim 16, wherein the razor cartridge is removably mounted on the handle.

19. The wet shaving system of claim 16, wherein the razor cartridge is pivotally mounted on the handle.

20. The wet shaving system of claim 16, wherein the arcuate channels extend lengthwise on the skin-engaging surface.

21. The razor cartridge of claim 16, wherein at least one of the arcuate channels has a radius that varies from at least one other of the arcuate channels.
